(19) United States
(12) Patent Application Publication
(10) Pub. No.: US 2006/0181521 A1
(43) Pub. Date: Aug. 17, 2006

(54) Systems for dynamically illuminating touch sensors

(75) Inventors: George Perreault, Campbell, CA (US); Anthony Gioeli, Los Gatos, CA (US)

Correspondence Address: HAVERSTOCK & OWENS LLP, 162 NORTH WOLFE ROAD, SUNNYVALE, CA, 94086, US

(73) Assignee: Atrua Technologies, Inc.

(21) Appl. No.: 11/400,431

(22) Filed: Apr. 6, 2006

Related U.S. Application Data
(63) Continuation-in-part of application No. 11/058,514, filed on Feb. 14, 2005.
(60) Provisional application No. 60/669,520, filed on Apr. 8, 2005.

(51) Int. Cl. G09G 5/00

(52) U.S. Cl. 345/173

(57) ABSTRACT

A system for and method of illuminating a contact (or touch) device such as a fingerprint sensor are disclosed. In an exemplary system, a touch sensor system has a surface or contact area and comprises a substantially transparent molding positioned over the contact area and a dynamic illuminator positioned to show through the molding. The dynamic illuminator is for indicating a status of the touch sensor system, such as power on, standby, error, low power, an input mode for receiving user input, or a selected operating mode. The touch sensor system includes any one of a fingerprint sensor, a miniature joystick, a touch-sensitive navigation disc, a touch-sensing navigation pad, an N-way pressure-sensitive directional control, to name a few touch sensor devices. In one embodiment, when the touch sensor comprises a fingerprint sensor, the operating mode is for emulating an input device such as a scroll wheel, a push button, a steering wheel, a joy stick, a pressure button, and a mouse. The operating mode also includes an authentication mode for authenticating an identity of a user. Preferably, the dynamic illuminator includes light sources and multiple light channels, colored or not, that are configured to be illuminated in multiple configurations, where each configuration corresponds to a status of the touch sensor system.

### RELATED APPLICATIONS

This application claims priority under 35 U.S.C. § 119(e) of the co-pending U.S. provisional patent application Ser. No. 60/669,520, filed Apr. 8, 2005, and titled “Dynamically Illuminated Biometric Sensor, Modular Packaging Technology, and Over-Current Chip Protection Architecture,” which is hereby incorporated by reference. This application is also a continuation-in-part application of the co-pending U.S. patent application Ser. No. 11/058,514, filed Feb. 14, 2005, and titled “A Customizable Touch Input Module for an Electronic Device,” which is also hereby incorporated by reference.

### FIELD OF THE INVENTION

The present invention relates to electronic input devices. More particularly, the present invention relates to systems for and methods of illuminating touch sensors.

### BACKGROUND OF THE INVENTION

Touch sensors are used on an ever increasing number of electronic devices. Touch sensors include joy sticks, pressure sensors, navigation buttons, and fingerprint sensors, to name a few devices that function by contacting a surface. Touch sensors function as input devices such as menu navigators, scroll wheels, and user identification modules. Because of their relatively small size, touch sensors are especially useful on portable devices, where space is limited. This limited space leaves little room for indicators to show whether the touch sensor is operating correctly, whether it is being used as a menu navigator or as a scroll wheel, or whether it is in power on or standby mode, to name a few possible statuses of the touch sensor.

Furthermore, it is difficult to customize portable devices that use touch sensors to indicate the status of the touch sensors. For example, when a cell phone incorporates a touch sensor, it is costly to configure the cell phone so that its LCD displays the status of the touch sensor.

### SUMMARY OF THE INVENTION

The present invention is directed to systems for and methods of indicating the status of touch sensors. An exemplary system of the present invention uses a dynamic illuminator positioned next to a contact surface of the touch sensor and used to display the status of the touch sensor. The displayed status can indicate, for example, that the touch sensor is (1) in standby mode, thereby conserving power; (2) in power on mode; (3) waiting to receive input, that is, ready to be contacted by a finger to launch a function or to verify a user's identity; (4) currently functioning as a scroll wheel; or (4) currently functioning as a push button, to name a few statuses. Preferably, the dynamic illuminator is positioned near or even surrounds a contact area of the touch sensor so that the touch sensor can be easily located in a darkened room.

In a first aspect of the present invention, a touch sensor system has a surface and includes a substantially transparent molding positioned over the surface and a dynamic illuminator positioned to show through the molding. The dynamic illuminator is configured to indicate a status of the touch sensor system, such as power on, standby, error, low power, an input mode for receiving user input, or an operating mode of the touch sensor system. The touch sensor system includes any one of a joy stick module, a touch-sensitive navigation disc, a touch-sensing navigation pad, a pressure-sensitive directional control, and a fingerprint sensor, to name a few devices. In one embodiment, the operating mode is for emulating a scroll wheel, a push button, a steering wheel, a joy stick, a pressure button, or a mouse, any of which can be selected by a user. The operating mode can also be a verification mode for verifying an identity of a user. In the verification mode, the identity of a user is determined from his fingerprint before he is allowed to access system resources.

Preferably, the dynamic illuminator includes one or more light channels configured to be illuminated in multiple configurations. Each configuration corresponds to a status of the touch sensor system. As some examples, a status is indicated by illuminating a corresponding light channel from among the one or more light channels, by illuminating a corresponding light channel from the one or more light channels to an intensity corresponding to the status, by illuminating a combination of light channels from the one or more light channels corresponding to the status, by illuminating multiple light channels from the one or more light channels in a sequence that corresponds to the status, by flashing one or more light channels from the one or more light channels, or any combination of these, to name a few ways of configuring the illumination of light channels to indicate a status. Preferably, all of the light channels are LED light sources and are the same color but can be different colors and multiple colors. Alternatively, the light channels include optical fibers, light ribbons, or any other type of light conducting material.

Preferably, the system also includes a substrate having a metal surface disposed below the molding and used to reflect illumination from the dynamic illuminator to a user. Also, preferably, the dynamic illuminator surrounds a contact area (surface) of the touch sensor system. Alternatively, the dynamic illuminator borders the contact area. In one embodiment, the molding comprises one or more light channels.

In a second aspect of the present invention, a system includes a means for detecting contact to a surface of a contact device and a means for indicating a status of the contact device. Preferably, the means for indicating a status comprises a visual display. In alternative embodiments, the means for detecting contact includes a joystick module, a touch-sensitive navigation disc, a touch-sensing navigation pad, a pressure-sensitive directional control, or a fingerprint sensor, such as a fingerprint swipe sensor or a fingerprint placement sensor.

In a third aspect of the present invention, a method of fabricating an electronic device comprises forming a touch sensor having a contact area, forming a dynamic illuminator for indicating a status of the touch sensor, and forming a substantially transparent molding over both the surface and the dynamic illuminator. The touch sensor comprises any one of a joy stick module, a touch-sensitive navigation disc, a touch-sensing navigation pad, a pressure-sensitive directional control, and a fingerprint sensor.

Preferably, the dynamic illuminator includes one or more light channels configured to indicate a status of the touch sensor. Also, preferably, the touch sensor is formed on a substrate, and the method also includes forming a metal surface below the molding for reflecting illumination from the dynamic illuminator to a user.

### BRIEF DESCRIPTION OF THE DRAWINGS

FIG. 1 is a schematic perspective view of a mobile telephone having a customizable interface module for scrolling through a list of telephone numbers and automatically dialing a selected telephone number in accordance with the present invention.

FIG. 2 shows the relationship between a user interface, a customizable device interface, and an application program executing on the mobile telephone of FIG. 1 in accordance with the present invention.

FIG. 3 shows a table illustrating the mapping between the components of the interface module of FIG. 1 and the corresponding function within the application program that each performs.

FIG. 4 shows a display screen and a customizable interface module of a mobile telephone that executes a computer game emulating a racing car in accordance with the present invention.

FIG. 5 shows a table illustrating the mapping between the components of the interface module of FIG. 4 and the corresponding function within the computer game that each performs.

FIG. 6 shows a display screen and a customizable interface module of a digital camera in accordance with the present invention.

FIG. 7 shows a table illustrating the mapping between the components of the interface module of FIG. 6 and the corresponding function that each performs on the digital camera.

FIG. 8 shows an architecture comprising a customizable device interface in accordance with one embodiment of the present invention.

FIG. 9 is a flow chart depicting the steps to configure a customizable device interface in accordance with the present invention.

FIGS. 10-14 show face plates having various interface modules, configurations, and shapes and used with customizable device interfaces in accordance with the present invention.

FIGS. 15-17 are top views of a fingerprint sensor bordered on one edge by a dynamic illuminator that indicates a first status, a second status, and a third status, respectively, of the fingerprint sensor in accordance with one embodiment of the present invention.

FIGS. 18-20 are top views of a fingerprint sensor bordered on one edge by a dynamic illuminator that indicates a first status, a second status, and a third status, respectively, of the fingerprint sensor in accordance with another embodiment of the present invention.

FIGS. 21-23 are top views of a fingerprint sensor bordered on one edge by a dynamic illuminator that indicates a first status, a second status, and a third status, respectively, of a fingerprint sensor in accordance with another embodiment of the present invention.

FIGS. 24-27 are top views of a fingerprint sensor bordered on one edge by a dynamic illuminator that indicates a first status, a second status, a third status, and a fourth status, respectively, of the fingerprint sensor in accordance with another embodiment of the present invention.

FIG. 28 is a top view of a fingerprint sensor surrounded by multiple lights used to indicate statuses of the fingerprint sensor in accordance with the present invention.

FIG. 29 is a top view of a touch-sensing navigator surrounded by an optical ribbon, in accordance with the present invention.

FIG. 30 is a schematic block diagram of a fingerprint sensor, a dynamic illuminator, and a controller in accordance with the present invention.

FIGS. 31-34 show the steps of forming a touch sensor and dynamic illuminator in accordance with the present invention.

FIG. 35 shows a cross-section of a touch sensor system in accordance with the present invention, with a portion of a molding overhanging a dynamic illuminator.

FIG. 36 shows a miniature joystick surrounded by a dynamic illuminator in accordance with the present invention.

FIG. 37 shows a 9-way pressure sensitive direction control coupled to a dynamic illuminator in accordance with the present invention.

### DETAILED DESCRIPTION OF THE PREFERRED EMBODIMENT

In accordance with the present invention, a status of a touch sensor system is indicated by a dynamic illuminator that preferably includes multiple light channels. By illuminating combinations of light channels from multiple light sources or channels, the dynamic illuminator indicates that the touch sensor system is powered on, powered off, in a standby mode, has encountered an error, in an input mode in which it is waiting for user input, in an operating mode, in which it is emulating an input device such as a mouse, a scroll wheel, a push button, a joy stick, a cursor, and a pressure button, to name a few input devices. The light channels can be clear to accurately show the color of the illumination or colored to alter the light it channels.

As used herein, the term “touch sensor” is used generally to mean any device that functions by being contacted. Touch sensors accordingly include, but are not limited to, fingerprint sensors, including fingerprint swipe sensors and fingerprint placements sensors. One example of a fingerprint sensor is the Atrua Wings™ Fingerprint Touch Controls, from Atrua Technologies, Inc., at 1696 Dell Avenue, Campbell, Calif. 95008. Fingerprint sensors are described in U.S. patent application Ser. No. 10/099,558, filed Mar. 13, 2002, and titled “Fingerprint Biometric Capture Device and Method with Integrated On-Chip Data Buffering,” which is hereby incorporated by reference.

Touch sensors also include, but are not limited to, miniature joy stick modules, touch-sensitive navigation discs, touch-sensitive navigation pads, and pressure-sensitive directional controls. Some examples of these touch sensors are the Atrua Varatouch™ Analog Input Controls, also from Atrua Technologies, Inc. Touch sensors are described in U.S. Pat. No. 6,563,488, filed Sept. 24, 1998, and titled “Pointing Device with Integrated Switch”; U.S. Pat. No. 6,256,012, filed Aug. 25, 1998, and titled “Uninterrupted Curved Disc Pointing Device; and U.S. Pat. No. 5,949,325, filed Oct. 6, 1997, and titled “Joystick Pointing Device,” all of which are incorporated by reference.

Preferably, the dynamic illuminator borders a contact area of the touch sensor, thus making the touch sensor easy to locate and thus use. For example, when using the touch sensor in a darkened room, the dynamic illuminator can be configured to remain lit so that a user can easily locate it. Or, when the device of which the touch sensor forms a part is misplaced, the illuminated dynamic illuminator also makes the device easy to locate.

Touch sensors and dynamic illuminators in accordance with the present invention are able to be used on any number of electronic devices such as computers, photocopy machines, and the like, but they are especially useful on portable devices such as cell phones, digital cameras, personal digital assistants, games devices, game controllers, and the like.

In some embodiments, the dynamic illuminator can be customized so that the lights are illuminated according to customer specifications. For example, one customer may request that power on mode be indicated by illuminating a green light and an error by a flashing red light. Another customer may request that power on be indicated by illuminating a blue light. Any combination of lights, including a constant illumination of specific colored lights or a flashing illumination of lights, are able to be used to indicate statuses in accordance with the present invention.

Many of the examples that follow are directed to fingerprint sensors. It will be appreciated, however, that other touch sensors are able to be used in accordance with the present invention. The use of fingerprint sensors is in no way intended to limit the invention to fingerprint sensors.

In accordance with other embodiments of the present invention, an electronic housing containing a user interface is able to be integrated with any number of electronic devices, such as a mobile telephone, a digital camera, a game device, and a game controller. In one embodiment, the user interface contains input components, including a fingerprint sensor and one or more additional touch sensors, such as a push button, a scroll wheel, a joy stick, a touch pad, a dial, and a pressure sensor. The user interface is configured to provide to a host system electronic signals, data, and control information corresponding to electronic signals, data, and control information generated by a user input device. Alternatively, the user interface also contains output components such as speakers, light emitting diode (LED) displays, and liquid crystal displays (LCDs). Using a method of the present invention, a user is able to select a housing to suit his particular needs, select an electronic device, and then have an interface between the housing and the electronic device customized so that the user interface provides the functions needed or supported by the electronic device and the applications running on it. A user is thus able to select housings based on their look and feel, the types and number of input components they have, or any other criteria.

Embodiments of the present invention are able to be used with many application programs including, but not limited to, a telephone application program, a game application program, and a digital camera application program, all of which support various functions. For example, the telephone application program supports the functions of displaying a list of telephone numbers, scrolling through the list, selecting a telephone number in the list, and automatically dialing the selected telephone number.

In accordance with the present invention, a user is able to choose a product with a desirable housing having a fingerprint sensor and a push button as part of the user interface. The user then selects a mobile telephone as the electronic device because he wishes to use the electronic device to store phone lists and then dial phone numbers selected from the phone list. A first device interface between the user interface and the mobile phone is then customized so that the fingerprint sensor is used to scroll through the phone list and the push button is used to automatically dial a selected telephone number. The user can also select a second product with a housing having the same user interface, but selects a digital camera as the electronic device, having different requirements of the user interface. In one embodiment, the fingerprint sensor is now used to focus the lens of the digital camera. In this embodiment, the device interface is now customized so that the fingerprint sensor controls the focus of the lens as needed. As described in more detail below, customizing the device interface in accordance with the present invention comprises mapping each component of a user interface (e.g., an output of a fingerprint sensor, of a push button, of a scroll wheel, etc.) to a particular function used by the electronic device or an application executing on the electronic device. In one embodiment, this mapping is performed by software but alternatively is performed by hardware components such as an application specific integrated circuitry (ASIC), which may or may not be incorporated in the fingerprint sensor.

Embodiments of the present invention allow device interfaces to be customized when the electronic device is assembled, allowing the electronic devices to be paired with any number of suitable housings having any number of device interfaces. This flexibility reduces production time and costs and eliminates the need for a universal device interface that may not be optimal to fit a particular application. This mapping also allows greater flexibility in what functions the user interface can support. For example, a fingerprint sensor and an additional touch sensor are able to be mapped to more functions. As one example, swiping a fingerprint sensor on the user interface maps to one function (e.g., authenticate the identity of a user, verifying that he has the right to use a mobile telephone), swiping the fingerprint sensor while pressing a push button maps to another function (e.g., scroll through a phone list displayed on the mobile telephone), and pressing the push button alone maps to another function (e.g., dial a selected telephone number). Thus, embodiments of the present invention allow a fingerprint sensor and an additional touch sensor to be used cooperatively, in conjunction with one another, to increase the number of available functions supported by a user interface.

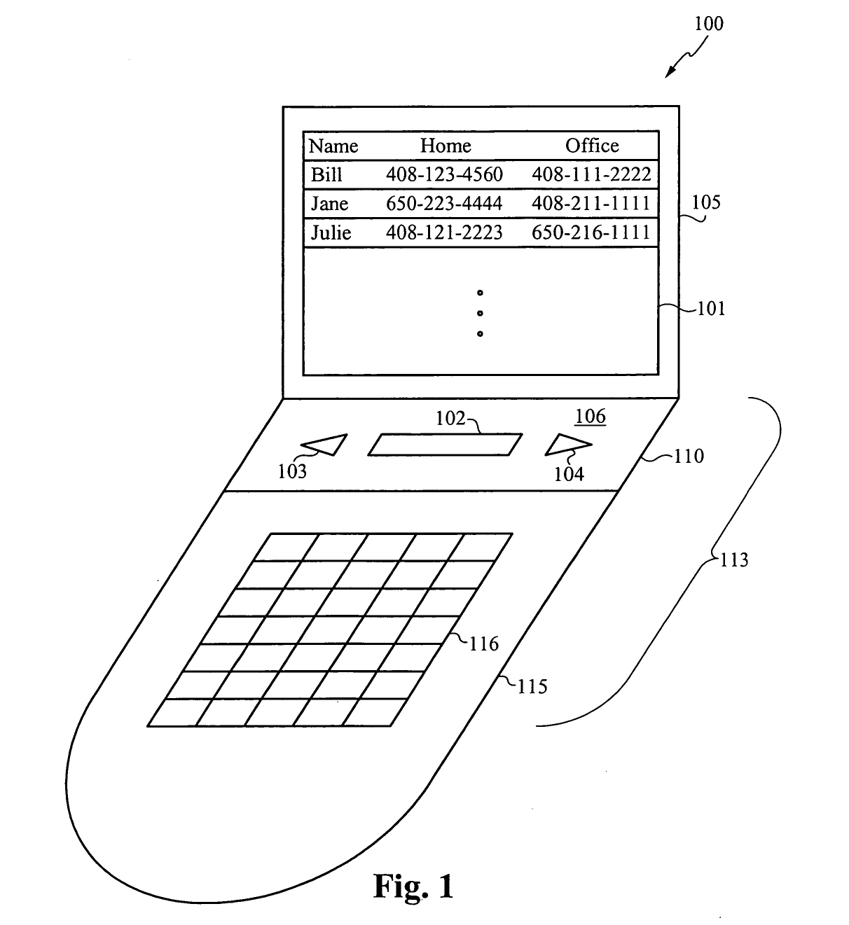

FIG. 1 shows a mobile telephone 100 having a customizable device interface in accordance with the present invention. The customizable device interface has been customized to allow the mobile telephone 100 to control a telephone application program executing on the mobile telephone 100. The exemplary interface allows a user to scroll through a phone list, select a telephone number, and automatically dial the selected telephone number. In other embodiments, the customizable device interface is customized to perform other tasks, such as to control a computer game executing on the mobile telephone 100.

The mobile telephone 100 has a lid 105 coupled to a hand set 113. The lid 105 contains a display screen 101 displaying a list of names and corresponding home and office telephone numbers generated by the telephone application program. The hand set 113 comprises a user interface module 110 and a bottom section 115, which contains a number pad 116. The user interface module 110 comprises a user interface 106 and a customized device interface (not shown). The device interface couples the user interface 106 to the telephone application program. As described in more detail below, the device interface is customized in accordance with the present invention.

The user interface 106 comprises user interface components including a fingerprint sensor 102, a left arrow button 103, and a right arrow button 104. Each user interface component is mapped to a function executed by the telephone application program.

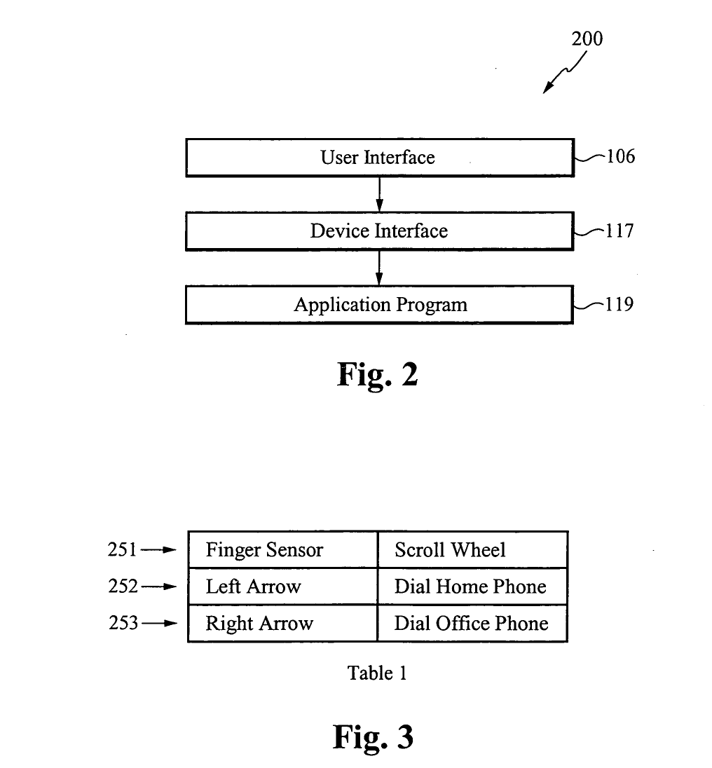

FIG. 2 shows the relationship between the user interface 106, the telephone application program 119, and a customizable device interface 117 operationally coupling the user interface 106 to the telephone application program. In operation, the customizable device interface 117 receives signals, data, control and status information, or any combination of these (collectively, component output data) from the user interface 106 and translates the component output data into application input data recognized by the telephone application program 119, thereby allowing a user to use the fingerprint sensor 102 to scroll through the list of names shown on the display screen 101 and to select a name from the list of names by, for example, swiping or tapping his finger on the fingerprint sensor 102. The customizable device interface 117 then receives component output data from the left arrow button 103 or the right arrow button 104 that is translated into application input data that perform the function of automatically dialing a telephone number corresponding to the selected name. For example, the user presses the left arrow button 103 to have the mobile telephone 100 automatically dial the home telephone number corresponding to the selected name. Alternatively, the user presses the right arrow button 104 to have the mobile telephone 100 automatically dial the office telephone number corresponding to the selected name.

Table 1 in FIG. 3 shows the relationship between the components of the user interface 106 in FIG. 1 and the function that each is configured to perform. Referring to FIGS. 1 and 3, Table 1 contains rows 251, 252, and 253. Row 251 shows that the fingerprint sensor 102 is used to generate component output data that the telephone application program interprets as application input data corresponding to movement by a scroll wheel. The fingerprint sensor 102 is thus said to emulate (e.g., is mapped to) a scroll wheel. Thus, when a user swipes his finger over the fingerprint sensor 102, the list of user names is scrolled up or down, depending on the direction of the swipe. Device emulation using a fingerprint sensor is described in more detail in U.S. patent application Ser. No. 10/873,393, titled “System and Method for a Miniature User Input Device,” and filed Jun. 21, 2004, which is hereby incorporated by reference. When the user swipes his finger across the fingerprint sensor 102, the component output data generated by the fingerprint sensor 102 are transmitted to the customizable device interface 116, which then translates the component output data into application input data that the application program recognizes as data generated by a scroll wheel, thereby scrolling the list of names shown in the display screen 101. In one embodiment, the name at the top of the list of names is automatically highlighted. Those skilled in the art will recognize that other names in the list can be highlighted in other ways in accordance with the present invention.

Still referring to FIGS. 1 and 3, row 252 shows that the left-arrow button 103 is mapped to the function of selecting the left-most telephone number (home telephone number) corresponding to the highlighted name. In a similar manner, the right-arrow button 104 is mapped to the function of selecting the right-most telephone number (office telephone number) corresponding to the highlighted name.

The structure used to map components of the user interface to corresponding functions can be configured in many ways. In one embodiment, the mappings (e.g., translations) are performed by one or more software programs stored in a memory of the customizable device interface 117. Alternatively, the mappings are formed as part of application specific integrated circuitry (ASIC) configured during assembly of the mobile telephone 100. Those skilled in the art will appreciate that the mapping can be performed in any number of ways.

In accordance with the present invention, an original equipment manufacturer (OEM) is able to use the same user interface 106, package it in a different housing, and use it in another product, such as an electronic game. The OEM merely customizes a device interface in accordance with the present invention to package a selected housing containing a user interface with any number of electronic devices. FIG. 4 illustrates one example of how the user interface 106 is used in a different product, requiring that the input components be mapped to different functions.

FIG. 4 shows a portion of a mobile phone 120′ having a device interface that has been customized differently from the device interface described in FIG. 1. A user interface module 110′ comprises the user interface 106 and a customizable device interface (not shown). (Throughout the Specification, like-numbered elements refer to the same element.) The customizable device interface of FIG. 4 has been customized to map the components of the user interface 106 to the functions used to simulate a racing car game. The device interface of FIG. 4 has been customized so that the component output data generated by the fingerprint sensor 102 is now used to emulate a steering wheel and a gas pedal of a racing car for a racing car game executing on the mobile phone 120′. In this game, a user traces his finger along a surface of the fingerprint sensor 102 to simulate the turning of a steering wheel for the racing car traveling along a driving course displayed on a display screen 122, which is mounted on the lid 105. The user is also able to change the pressure of his finger on the fingerprint sensor 102 to emulate the pressure on an accelerator of the racing car, to thereby accelerate or decelerate the racing car. The user is able to press the left-arrow button 103 to emulate up-shifting and the right-arrow button 104 to emulate down-shifting of the gears of the racing car.

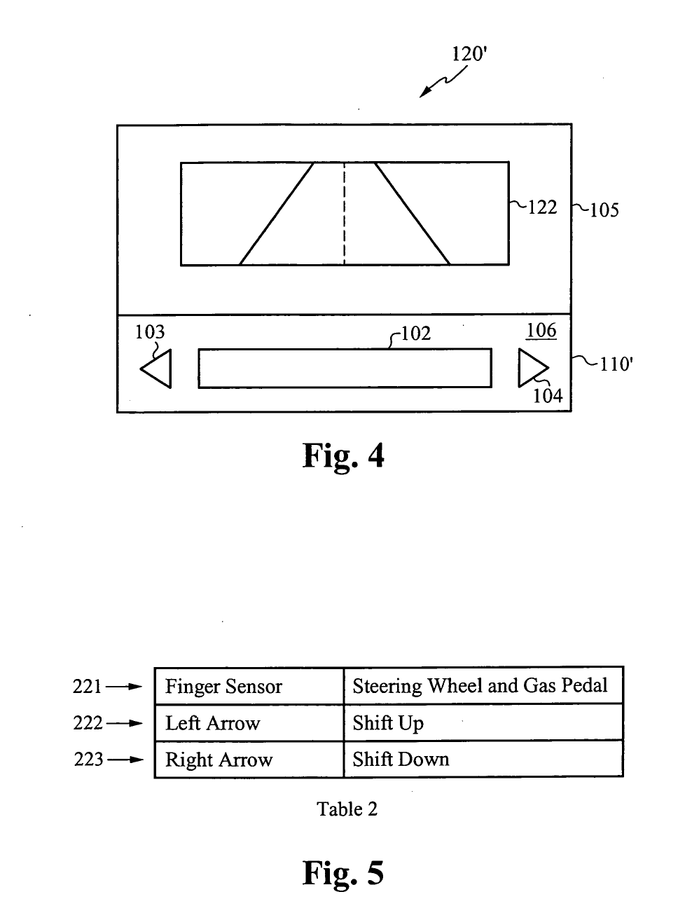

FIG. 5 shows Table 2, which illustrates the mapping performed by the customized device interface on the mobile telephone 120. Table 2 contains rows 221, 222, and 223, with each component shown in the left column of each row being mapped to a function in the corresponding right column. Thus, row 221 illustrates that the fingerprint sensor 102 of the mobile telephone 120 is mapped to the function of emulating a steering wheel and gas pedal; row 222 illustrates that the left-arrow button 103 is mapped to the function of shifting the gears of the racing car up; and row 223 illustrates that the right-arrow button 104 is mapped to the function of shifting the gears of the racing car down.

While FIGS. 1 and 4 show a single user interface 106 used on the same electronic device (a mobile telephone), it will be appreciated that a single user interface is able to be mounted on any number of electronic devices and customized in accordance with the present invention to perform functions for operating the electronic device or an application executing on it. Moreover, as described below, user interfaces having any combination of user interface components are able to be customized in accordance with the present invention.

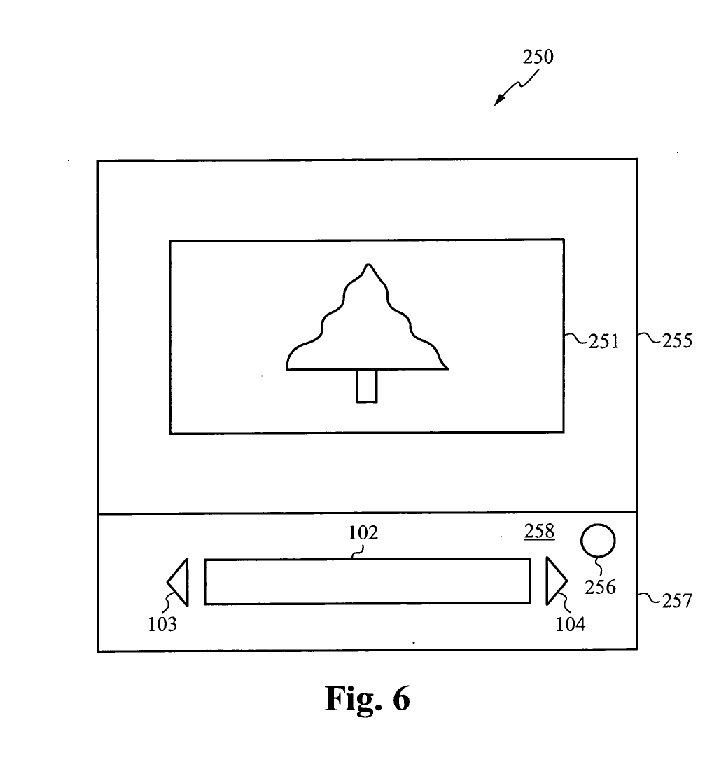

FIG. 6 shows a digital camera 250 comprising a top portion 255 and an interface module 257. The top portion 255 contains a display screen 251 and the user interface module 257 contains a user interface 258. The user interface 258 contains as user interface components the fingerprint sensor 102, the left-arrow button 103, the right-arrow button 104, and a push button 256. Again, identical elements are used in FIGS. 1, 4, and 6 to highlight that similar or identical interface components are able to be customized to perform different functions depending, for example, on the device that the interface module is ultimately used.

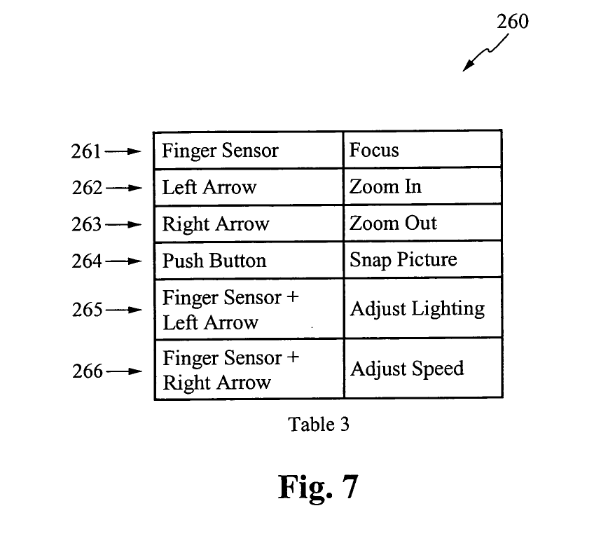

FIG. 7, containing Table 3, contains rows 261-266 showing how interface components in FIG. 6 map to camera-related functions. Multiple elements can be activated simultaneously (e.g., pressing the left-arrow button 103 and the push button 256 simultaneously) to perform specific functions. Thus, row 261 indicates that pressing the fingerprint sensor 102 will control the focus of the digital camera 250 by, for example, translating (mapping) component output data into application input data used by a camera application program executing on the digital camera 250. Row 262 indicates that pressing the left-arrow button 103 zooms the focus on the digital camera 250 in. Row 263 indicates that pressing the right-arrow button 104 zooms the focus on the digital camera 250 out. Row 264 indicates that pressing the push button 256 snaps a picture on the digital camera 250. Row 265 indicates that pressing a finger on the fingerprint sensor 102 while pressing the left-arrow button 103 adjusts the lighting for the digital camera 250. By pressing the fingerprint sensor 102 and the left-arrow button 103 simultaneously to perform a function, the two are said to function cooperatively. And row 266 indicates that pressing a finger on the fingerprint sensor 102 while pressing the right-arrow button 104 adjusts the shutter speed for the digital camera 250.

It will be appreciated that a single electronic device is able to be used to perform any number of functions. For example, in one embodiment the mobile telephone 100 of FIG. 1 is configured to operate as a mobile telephone, as a digital camera, or both. In this case, the mobile phone is able to be used with a customized device interface so that it supports the functions of a mobile telephone, a digital camera, another electronic device, or any combination of these.

The present invention is also able to map activating (e.g., pressing or swiping) a fingerprint sensor, a mechanical button, or both, to a function depending on the context. For example, when an electronic device is first powered on, a fingerprint sensor is able to be mapped to the function of authenticating the user to determine whether he is to be allowed access to the electronic device. Later, when the electronic device is executing a game program, the fingerprint sensor can be mapped to emulate a steering wheel.

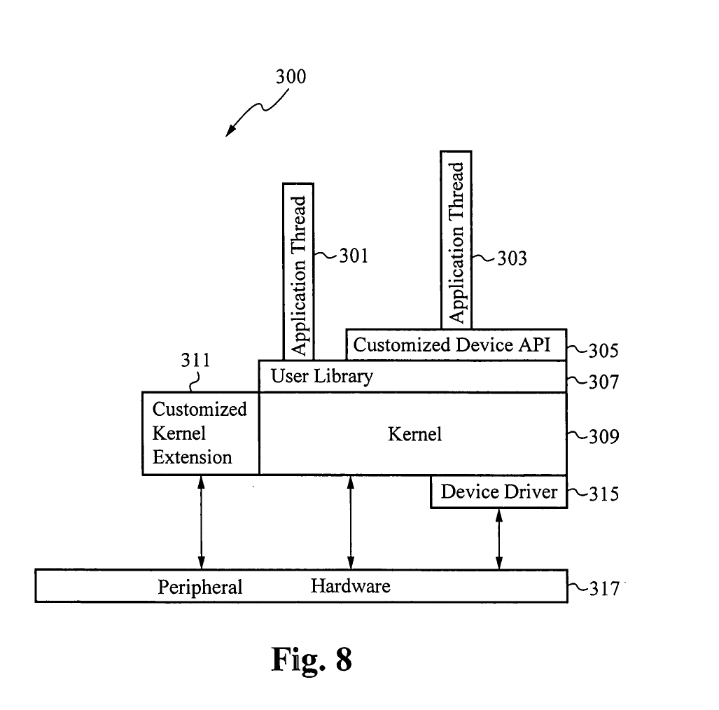

While FIG. 2 shows a general overview of the architecture for one embodiment of the present invention, FIG. 8 gives a more detailed view of a customized architecture 300 for practicing the invention using the Symbian OS™ for mobile telephones. The customized architecture 300 allows an application program (such as a telephone application program) to communicate with peripheral hardware devices 317, such as a fingerprint sensor or other touch sensor of a user interface such as the user interface 106 of FIG. 1. The customized architecture 300 comprises peripheral hardware 317 comprising any one or more of a fingerprint sensor, a left-arrow button, a right-arrow button, a push button, a joy stick, a jog dial, a scroll wheel, a pressure sensitive button, a touch screen, etc. The peripheral hardware 317 is coupled to a kernel extension 311, a kernel 309, and a device driver 315. The kernel 309 provides the basic operating system functions, including providing access to necessary peripherals such as timers. The kernel extension 311 extends the functioning of the kernel 309 by allowing the operating system to access the peripheral hardware 317. The kernel 309 in turn is coupled to the device driver 315 and to a user library 307 that allows application programs (including threads 301 and 303) to access the functions of the kernel 307. The user library is coupled to the application thread 301 and to a customized device API (application program interface) 305 that is also coupled to the application thread 303.

In one embodiment, the customized device API 305 corresponds to a customized device interface in accordance with one embodiment of the present invention. In this embodiment, the customized device API 305 translates a function normally associated with a user interface component into a function required by an application program. Thus, for example, if a fingerprint sensor is used to emulate a steering wheel, the system function associated with the fingerprint sensor is mapped to a function associated with the steering wheel. For example, if the architecture 300 passes messages to signify the occurrence of a steering wheel movement, the fingerprint sensor's component output data is mapped to a message that the application thread 303 recognizes as generated by a steering wheel. Alternatively, the architecture can use event generation or other methods to recognize the occurrence of a steering wheel movement.

In one example of operation, a fingerprint sensor is used to emulate a steering wheel to be used on a game device. In this example, a user swipes his finger on a fingerprint sensor that forms part of the peripheral hardware 317, which the device driver 315 uses to generate component output data. The kernel 309 in conjunction with the user library 307 translates this component output data to application input data (e.g., a system function) recognizable as that generated by a fingerprint sensor. The customized device API 305 translates this application input data into that recognizable as generated by a steering wheel. This application input data is then transmitted to the application thread 303, such as a car racing application program, which uses the input data to emulate turning the steering wheel.

The customized device API 305 is able to be loaded when a device containing the customized architecture 300 is configured, such as at an OEM. In accordance with the invention, a single component, such as the user interface 106, is able to be installed on many different products, and the mapping of its input components determined when the functioning of (e.g., the application programs executing on) the electronic device is determined. Thus, for example, if the input module 106 (FIG. 1) is placed in a mobile telephone, a customized device API can be loaded when the mobile phone is assembled so that the functioning of the input module 106 corresponds to that shown in Table 1 of FIG. 3. Alternatively, if the input module 106 is placed in a game device, a customized device API can be loaded when the game device is assembled so that the functioning of the input module 106 corresponds to that shown in Table 2 of FIG. 5. Thus, the customized device API 305 is able to be configured according to the present invention to allow a single input module to be used in a variety of products using a variety of packages.

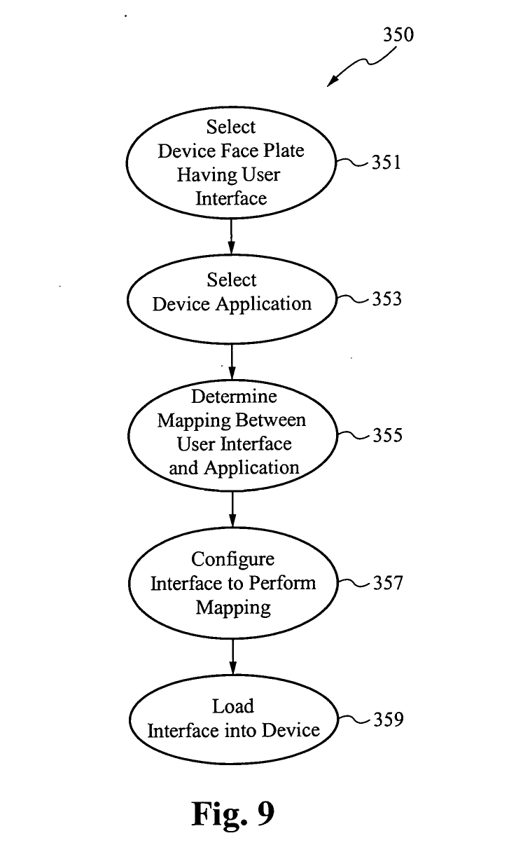

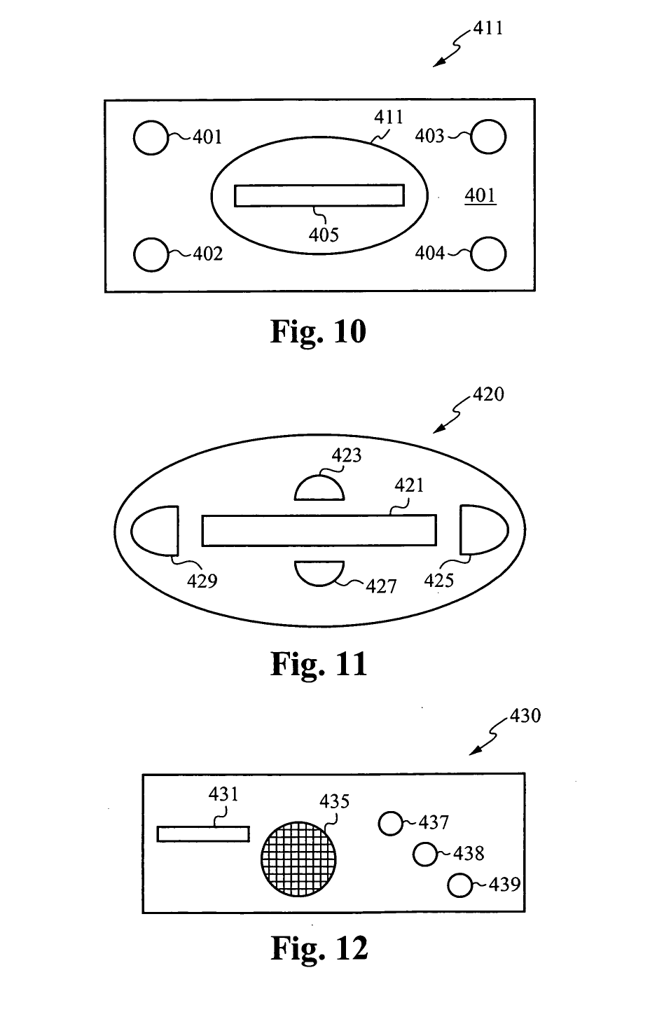

FIG. 9 is a flow chart 350 showing the steps used to customize a device interface in accordance with one embodiment of the present invention. First, in the step 351, a face plate having a user interface is selected based, for example, on its look and feel. Next, in the step 353, the functions that the underlying electronic device is used to perform is selected. In this step, for example, the application of the underlying device can be the emulation of a racing car, telephone and address book functions such as scrolling through a phone list and dialing telephone numbers, etc. Next, in the step 355, the mapping of the user interface components to the function of each component is determined, such as shown in Tables 1-3. Next, in the step 357 a customized device API (e.g., element 305 in FIG. 10) is configured to reflect the mapping determined in the step 355. Next, in the step 359, the customized API is loaded onto the electronic device, such as a mobile telephone, a game device, a digital camera, etc.

It will be appreciated that not all interface components on a user interface must be mapped to a corresponding function. Some user interface components may have no function when assembled on an electronic device.

It will also be appreciated that components in the architecture 300 are able to be implemented in other ways. For example, in one embodiment, the device driver 315 is used to map component output data into data that is ultimately recognized by the application thread 303 as application input data for a function supported by the application thread 303. In one embodiment, the device driver is implemented as an ASIC.

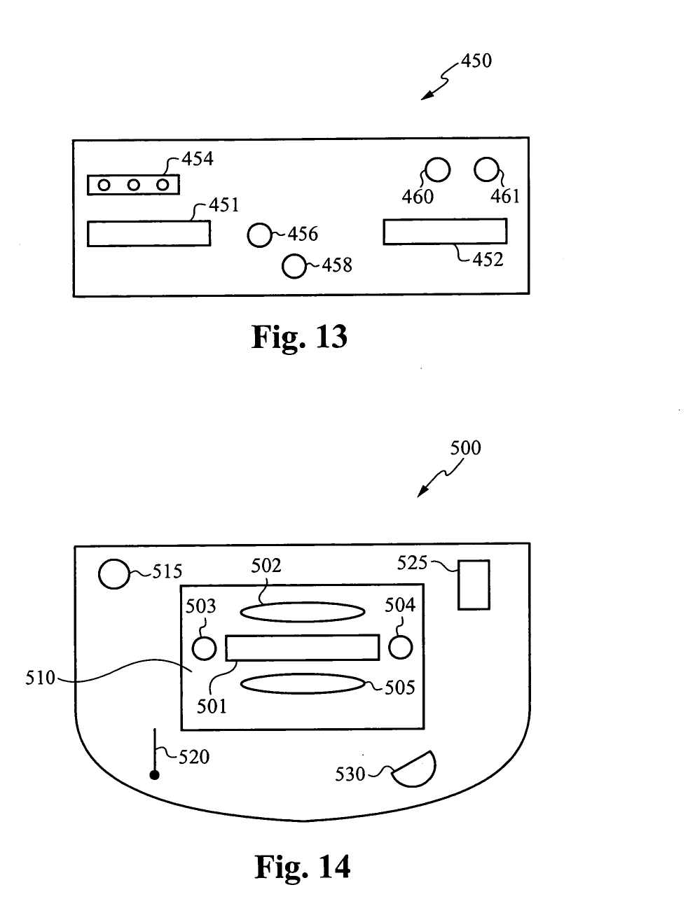

FIGS. 10-14 show several housings each having a corresponding user interface coupled to a device interface customized in accordance with the present invention. Each device interface is able to be customized for use on any number of electronic devices in accordance with the present invention. FIG. 10 shows a housing 411 having a face containing user interface components that include four push buttons 401-404 and a button 411 that also supports a fingerprint sensor 405. Using this configuration, the user interface components are able to be configured to perform a variety of functions. For example, the fingerprint sensor 405 is used to authenticate a user (such as by using an authentication module well known in the art), scroll through a phone list, or emulate a steering wheel. Referring to FIG. 10, a user is able to swipe or place a finger on the fingerprint sensor 405, push the button 411, or do both simultaneously, all to perform a corresponding function. FIG. 11 shows a housing 420 having a face containing user interface components that include a fingerprint sensor 421 and push buttons 423, 425, 427, and 429. FIG. 12 shows a housing 430 having a face containing user interface components that include a fingerprint sensor 431, a speaker 435, and push buttons 437-439. FIG. 13 shows a housing 450 having a face containing user interface components that include a first fingerprint sensor 451, a second fingerprint sensor 452, an LED bank 454, and push buttons 456, 458, 460, and 461. FIG. 14 shows a housing 500 having a face containing user interface components that include a fingerprint sensor 501, push buttons 502-505, a scroll wheel 525, ajog dial 515, a joy stick 520, and a push button 530. As FIGS. 10-14 show, housings used in accordance with the present invention can have any combination of size and shape selected for their look and feel or using other criteria.

In accordance with embodiments of the present invention, output displays such as the speaker 435 (FIG. 12) and LED bank 454 (FIG. 13) are coupled to user input components such as fingerprint sensors and push buttons to indicate, for example, that a button has been pushed. In other embodiments, the speakers are coupled to audio outputs such as when the underlying electronic device is a game system. In these other embodiments, the speakers are able to emulate sounds generated by the game, such as bombs exploding, etc. Also in these other embodiments, the LED bank 454 can be used to simulate explosions and other features of the game. As in other embodiments of the present invention, the output displays are also mapped to user interface components, to outputs generated by an application executing on an electronic device, or any combination of these.

By customizing a device interface in accordance with the present invention, electronic devices are able to be coupled with face plates having many combinations of interface components. A system and method in accordance with the present invention thus allow OEMs to use off-the-shelf application programs and device drivers, merely requiring that they customize the device interface. Such minimum modifications save time and money and allow electronic devices to use any number of ready-made application programs and device drivers on the market.

Systems and methods in accordance with the present invention also offer more combinations of interface components to be mapped to functions executable on the electronic device. The number of functions supported by, and thus the capabilities of, the electronic device is extended.

It will be appreciated that many variations can be made to the embodiments of the present invention. For example, while the above embodiments describe stand-alone systems, other electronic devices, such as a game controller, such as, but not limited to, the XBOX™, Nintendo Game Cube™, Sony PS, and Sony PS2, are able to be configured in accordance with the present invention. Other output components, such as back lights and LCD panels, are able to form part of the user interface. And while swipe fingerprint sensors, such as capacitive, thermal, and optical sensors, are described in the embodiments above, fingerprint placement sensors can also be used.

In other embodiments of the present invention, a fingerprint sensor is customized by providing a dynamic illuminator configured to display a status of the fingerprint sensor and also, when illuminated, to make the fingerprint sensor easier to locate. This is particularly useful when the fingerprint sensor is used on a device in a darkened room, such as during a presentation. Preferably, the dynamic illuminator borders, surrounds, is adjacent to, or is otherwise near enough to the fingerprint sensor to show a user where the fingerprint sensor, and thus the device to which it is attached, is located. The dynamic illuminator can thus be configured to illuminate or blink, thereby showing its location.

As one example, the dynamic illuminator includes multiple lights that include a first light and a second light. The lights are illuminated a first way to indicate that the fingerprint sensor is in a first mode in which it is used to emulate a scroll wheel and the lights are illuminated a second way to indicate that the fingerprint sensor is in a second mode in which it is used to emulate a push button. In the first mode, only the first light is illuminated and in the second mode only the second light is illuminated. Or, in the first mode the first light shines brightly, and in the second mode the first light shines dimly. Or, in the first mode the first and second lights shine constantly and in the second mode the two lights blink, flashing on and off quickly. It will be appreciated that the lights are able to be illuminated in many different configurations (e.g., illumination patterns), each indicating a different status of the fingerprint sensor.

It will also be appreciated that a fingerprint sensor is able to be placed in different modes in many ways. As one example, a user can tap a contact area of the fingerprint sensor in a first pre-determined way or sequence to place the fingerprint sensor is one mode and tap the contact area in a second way or sequence to place the fingerprint sensor in a second mode. Alternatively, the user can tap the contact area with his right index finger to place the fingerprint sensor in the first mode and with his right thumb to place the fingerprint sensor in the second mode. Those skilled in the art will appreciated other ways to select modes. Viewing the dynamic illuminator in accordance with the present invention, a user is able to quickly determine what mode the fingerprint sensor is in.

The fingerprint sensor is able to be customized so that the dynamic illuminator indicates different statuses. As some examples, different configurations of the dynamic illuminator are used to indicate that the fingerprint sensor is on, is in standby mode, has encountered an error, has low power (such as when it is a stand-alone module and is powered by a battery), is awaiting a user to provide input such as by tapping a contact area of the fingerprint sensor, is in an emulation mode emulating a particular input device, or is in an authentication mode in which it authenticates the identity of a user from his fingerprint.

Dynamic illuminators in accordance with the present invention can include many different means of illumination such as an LED or light channels, which include, but are not limited to, optical fibers and light ribbons. Light channels in accordance with the present invention are able to be uncolored or colored in many ways. For example, light channels can be clear and colored at their ends by one or more colored LEDs. Alternatively, the light channels themselves can be colored and illuminated by white LEDs to produce colored illumination. In some of the examples that follow, the term light or LED is used for example only. Illumination is accomplished through light emitting sources, with or without light transmitting channels.

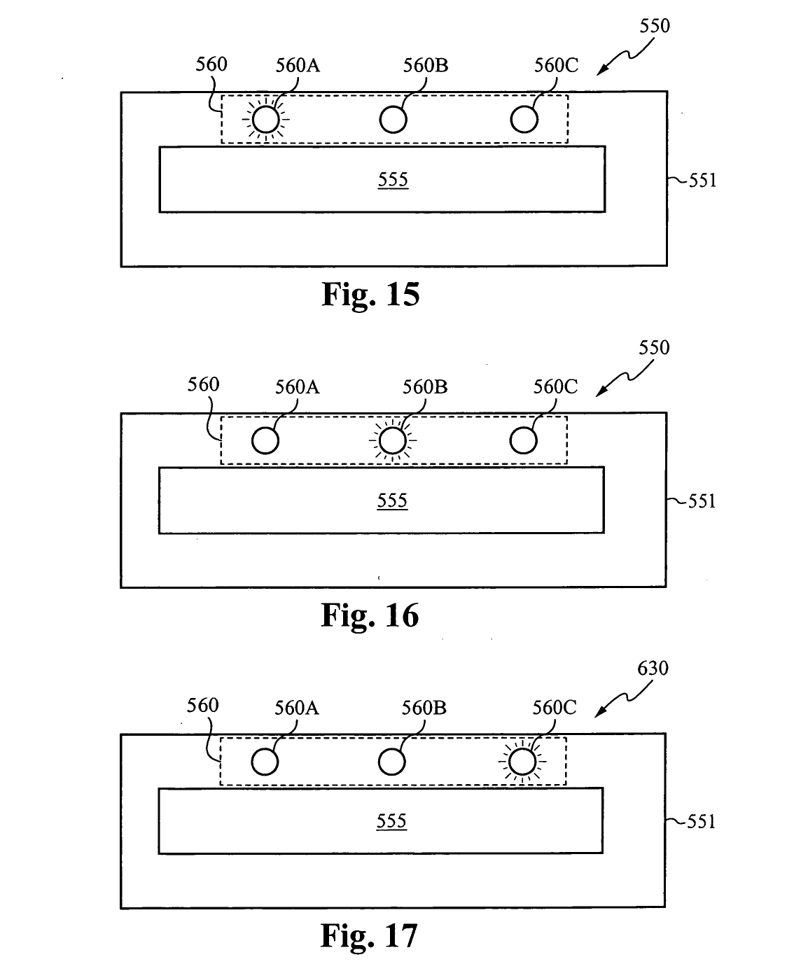

FIGS. 15-18 show a fingerprint sensor system 550 in different modes (indicated by different statuses) in accordance with one embodiment of the present invention. The fingerprint sensor system 550 comprises a substrate 551, a contact area 555 of a fingerprint sensor, and a dynamic illuminator 560 that borders a first edge of the contact area 555. The dynamic illuminator 555 includes lights 560A-C, such as light emitting diodes (LEDs). The illuminator 555 is dynamic in that its appearance (e.g., the illumination pattern of the lights 560A-C) changes to indicate a status of the fingerprint sensor. In FIG. 15, the light 560A is shown illuminated (by the lines radiating from it) and the lights 560B and C are shown unilluminated, indicating that the fingerprint sensor is powered on. FIG. 16 shows the light 560B illuminated and the lights 560A and 560C unilluminated, indicating the fingerprint sensor is in standby mode, thereby conserving power. FIG. 17 shows the light 560C illuminated and the lights 560A and 560B unilluminated, indicating the fingerprint sensor is waiting for a user to swipe a finger across the contact area 555, to authenticate the identity of the user before the user is allowed to use a device coupled to the fingerprint sensor system 550.

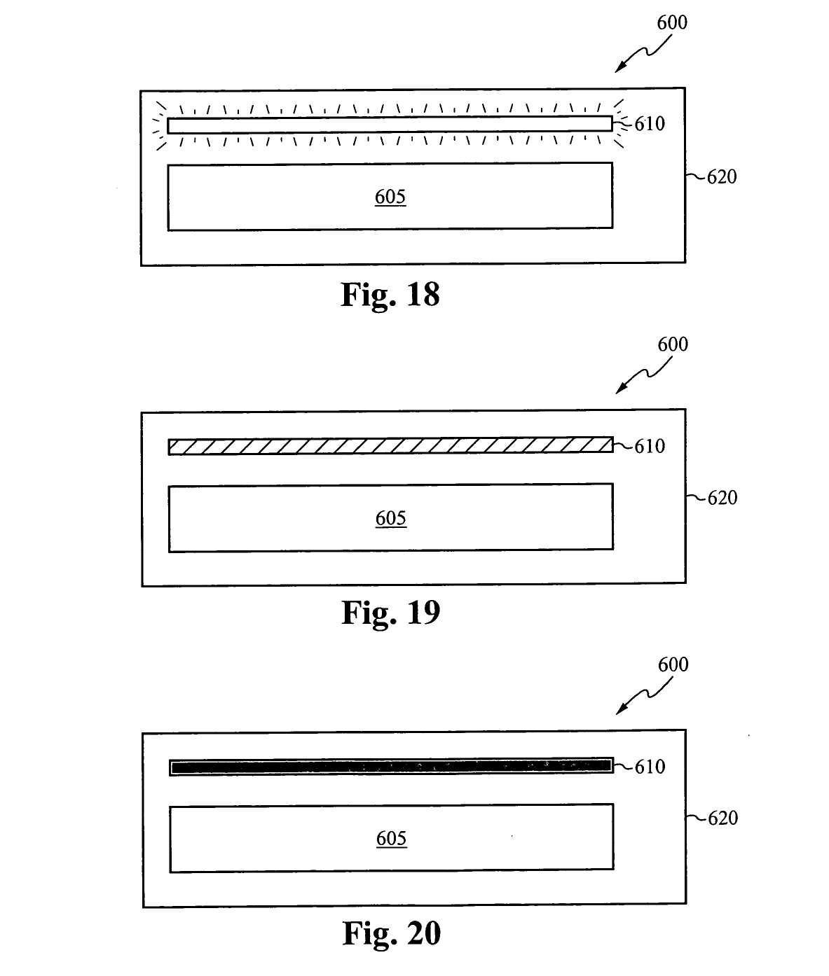

FIGS. 18-20 show a fingerprint sensor system 600 in different modes in accordance with another embodiment of the present invention. The fingerprint sensor system 600 comprises a substrate 620, a contact area 605 of a fingerprint sensor, and a dynamic illuminator 610 that borders a first edge of the contact area 605. In FIG. 18, the dynamic illuminator 610 is shown as illuminated (indicated by the lines radiating from it), indicating that the fingerprint sensor is powered on. FIG. 19 shows the fingerprint sensor system 600 with the dynamic illuminator 610 dimly lit (indicated by the hatching), indicating that the fingerprint sensor is in standby mode, thereby conserving power. FIG. 20 shows the fingerprint sensor system 600 with the dynamic illuminator 610 unlit (indicated by the darkened shading), indicating the fingerprint sensor is off.

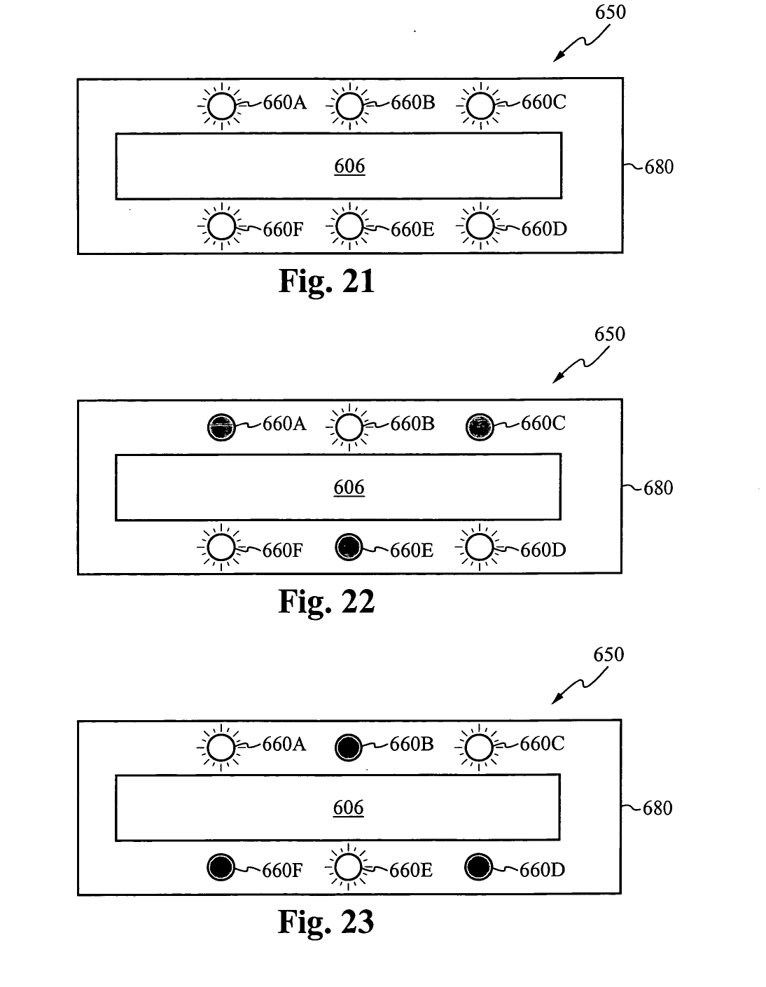

FIGS. 21-23 show a fingerprint sensor system 650 in accordance with another embodiment of the present invention. The fingerprint sensor system 650 comprises a substrate 680, a contact area 606 of a fingerprint sensor, and a dynamic illuminator that includes lights 660A-F. Preferably, the lights 660A-F are LEDs, though they can be other light sources. The lights 660A-C border a first edge of the contact area 606 and the lights 660D-F border a second, opposing edge of the contact area 606. The lights 660A-F are configured to be lit to indicate a status of the fingerprint sensor. FIG. 21, for example, shows the fingerprint sensor system 650 when the lights 660A-F all illuminated (indicated by the lines radiating from them), indicating that the fingerprint sensor is in a first emulation mode, in which it is used to emulate a scroll wheel. FIG. 22 shows the fingerprint sensor system 650 when the lights 660B, 660D, and 660 F are all illuminated and the remaining lights unilluminated (indicated by the dark shading), indicating that the fingerprint sensor is in a second emulation mode, in which it is used to emulate a push button. FIG. 23 shows the fingerprint sensor system 650 when the lights 660A, 660C, and 660 E are all illuminated and the remaining lights are all unilluminated, indicating that the fingerprint sensor is in a third emulation mode, in which it is used to emulate a mouse. It will be appreciated that other combinations of lights being on and off are able to be used to indicate that the fingerprint sensor is in other emulation modes for emulating other input devices, is in standby mode, has detected an error, is waiting for input, or is ready to authenticate a user, to name a few uses.

Systems for and methods of emulating input devices are described in more detail in U.S. patent application Ser. No. 10/873,393, titled “System and Method for a Miniature User Input Device,” incorporated by reference above.

In some embodiments of the present invention, a dynamic illuminator includes different colored lights, the illumination of which will indicate a status of a fingerprint sensor. In other embodiments, a dynamic illuminator includes lights, either colored or uncolored, that are flashed in different sequences, each used to indicate a status of the fingerprint sensor or merely to help a user identify the location of the fingerprint sensor or the host device to which it is attached.

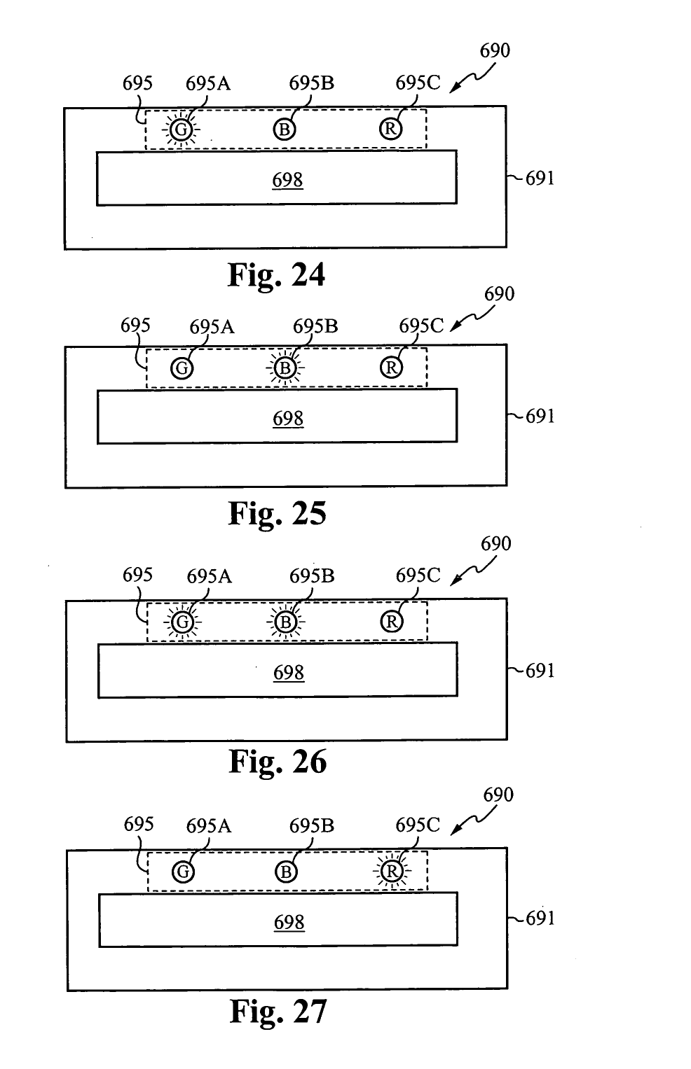

FIGS. 24-27 show a fingerprint sensor system 690 in accordance with another embodiment of the present invention, using colored lights to indicate a status of a fingerprint sensor system. The fingerprint sensor system 690 comprises a substrate 691, a contact area 698 of a fingerprint sensor, and a dynamic illuminator that includes a green light 695A, a blue light 695B, and a red light 695C (collectively, 695) that all border a first edge of the contact area 698. In FIG. 24, the dynamic illuminator 695 is shown with only the green light 695A illuminated (indicated by the radiating lines), indicating that the fingerprint sensor system 690 is powered on. FIG. 25 shows the fingerprint sensor system 690 with only the blue light 695B illuminated, indicating that the fingerprint sensor system 690 is in a first emulation mode. FIG. 26 shows the fingerprint sensor system 690 with only the green light 695A and the blue light 695B illuminated, indicating that the fingerprint sensor system 690 is in a second emulation mode. And FIG. 27 shows the fingerprint sensor system 690 with only the red light 695C illuminated, indicating that the fingerprint sensor system 690 is malfunctioning.

In one embodiment, the colored lights 695A-C are positioned sufficiently close together so that by controlling the intensities of each light, the colors are blended together to form intermediate colors. In this way, the combination of illuminated lights 695A-C are able to provide colors in a range of colors, each indicating a status of the fingerprint sensor 690. Preferably, the colors of the lights 695A-C are the primary colors, red, green, and blue, though the colors of each may be different from the primary colors.

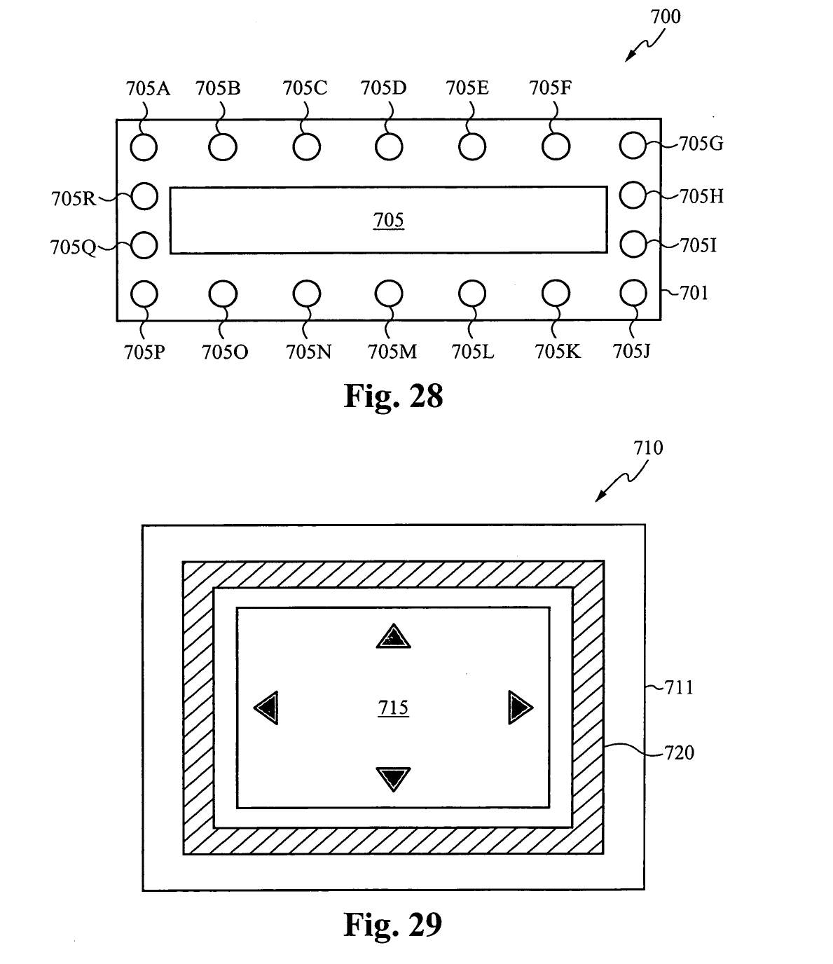

Dynamic illuminators are able to be positioned on or near a contact area of a fingerprint sensor in many ways. FIG. 28, for example, shows a fingerprint sensor system 700 comprising a substrate 701, a contact area 705 of a fingerprint sensor, and a dynamic illuminator formed by multiple lights 705A-R that surround the contact area 705. The lights 705A-F border a first edge of the contact area 705, and the lights 705J-P border a second edge of the contact area 705, opposing the first edge. The lights 705G-I border a third edge of the contact area 705, and the lights 705P-R border a fourth edge of the contact area 705, opposing the third edge.

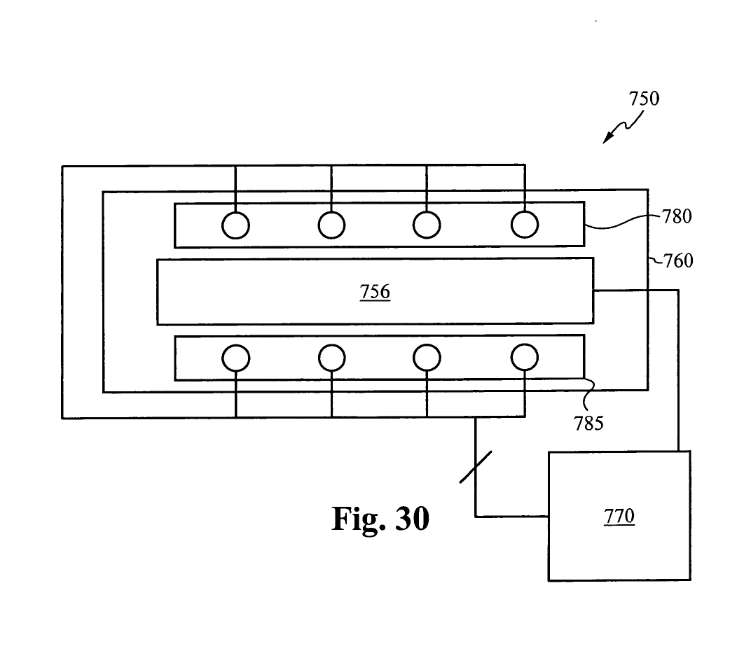

It will be appreciated that in one embodiment, the discrete lights 705A-R are replaced by a continuous optical ribbon that surrounds the contact area 705. FIG. 29, for example, shows a touch sensor system 710 formed on a substrate 711. The touch sensor system 710 includes a contact area 715 for a touch-sensing navigator surrounded by a dynamic illuminator formed of an optical ribbon 720 that provides an unbroken strip of light when illuminated. Dynamic illuminators in accordance with the present invention can have any number of shapes and configurations.

FIG. 30 is a schematic diagram of a fingerprint sensor system 750 in accordance with one embodiment of the present invention. The fingerprint sensor system 750 comprises a substrate 760, a contact area 706 of a fingerprint sensor, a dynamic illuminator that includes a first block 780 of lights and a second block 785 of lights, and a control module 770. The control module 770 is coupled to the contact area 706, to the first block 780 of lights and to the second block 785 of lights.

In operation, the controller 770 controls the dynamic illuminator 780 and 785 to indicate a status of the fingerprint sensor system 750. The controller 770 is able to determine and update the status of the fingerprint sensor system 750. Preferably, the status is able to be changed by contacting the contact area 706 in a pre-determined manner. As one example, when a user taps once on the contact area 706, the fingerprint sensor system 750 is placed in a power on mode. Thus, when a user taps once on the contact area 706, electronics in the fingerprint sensor system 750 recognize the single tap, place the fingerprint sensor system 750 in the power on mode, transmits this information to the controller 770, which then illuminates the lights in the first block 780 and the second block 785 to indicate that the fingerprint sensor is now in the power on mode. Similarly, when the fingerprint sensor system 750 has encountered an error, such as when it has suffered damage from electrostatic discharge, the fingerprint sensor system 750 transmits corresponding information to the controller 770, which then causes the lights in the first block 780 and the second block 785 to blink or to illuminate only red lights, indicating that an error has been encountered. Preferably, the controller 770 is customized when the fingerprint sensor system 750 is being assembled, so that the controller 770 is able to illuminate the dynamic illuminator 780 and 785 in any manner specified by a customer.

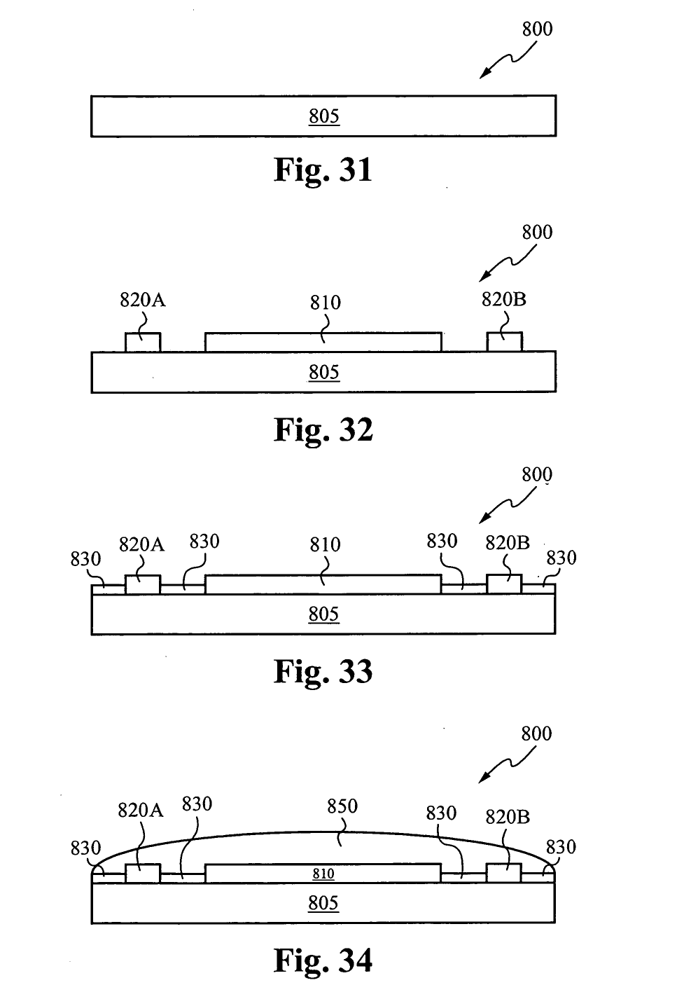

FIGS. 31-34 show the steps for fabricating a touch sensor system 800 in accordance with the present invention. As shown in FIG. 31, first a substrate 805 is provided. Next, as shown in FIG. 32, a touch sensor, comprising a contact area 810 and associated electronics (not shown) are formed on the substrate 805. Also, a dynamic illuminator including a first block 820A and a second block 820B, formed on opposing edges of the contact area 810, are formed. A controller (not shown), such as the controller 770 of FIG. 30, is coupled to both the contact area 810 and the first block 810 and the second block 820B. Next, as shown in FIG. 33, a metal layer 830 is formed between the contact area 810 and the first and second blocks 820A and 820B and also between the first and second blocks 820A and 820B and an outer edge of the substrate 805. Finally, as shown in FIG. 34, a clear plastic molding 850 is formed over the contact area 810, the first and second blocks 820A and 820B, and the metal layer 830. The clear plastic molding 850 protects the components of the touch sensor system 800 and is sufficiently transparent to allow a user to clearly view the first and second blocks 820A and 820B when illuminated to thereby determine the status of the touch sensor system 800. The metal layer 830 is used to reflect the illumination from the first and second blocks 820A and 820B to a user viewing the touch sensor system 800.

In other embodiments, the clear plastic molding 850 is a light channel that can, under software control, hardware control, or both, be dynamically changed to any color to indicate a status of the touch sensor system. In other embodiments, the metal layer 830 is replaced by a layer of paint selected to match or otherwise complement the host device of which the touch sensor system 800 forms a part. In still other embodiments, the substrate 805 is small enough (in depth, thickness, width, or any combination of these) that illumination from a dynamic illuminator is able to be seen through the substrate itself, thus giving a decorative appearance to the touch sensor system 800 as well as allowing the illumination to be viewed regardless of a viewer's orientation to the touch sensor system 800. In other words, a user can view the illumination even if the touch sensor system 800 is face down, placed on its end, etc.

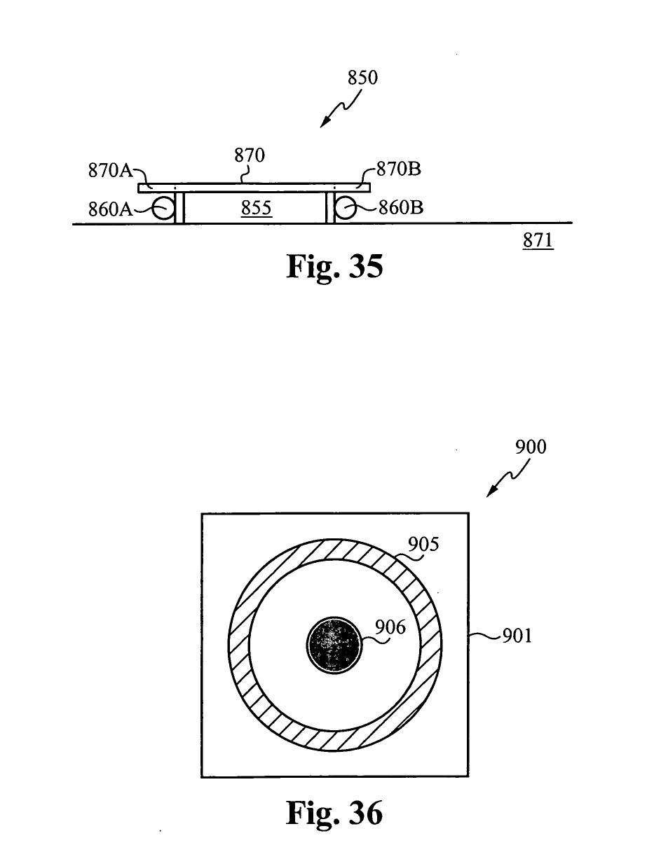

In other embodiments, the touch sensor integrated circuit molding can contain a light channel by using a clear compound to mold in an optical fiber or other light channel during package assembly. Alternatively, as shown in FIG. 35 and discussed below, the touch sensor IC package has a clear overhang and the light channel (such as an optical fiber) is placed or formed under the overhang.

It will be appreciated that while FIGS. 31-34 show a particular sequence of steps, the steps are able to be performed in other sequences and, indeed, some combinations of steps can be combined into a single step and some single steps can be performed as multiple steps.

FIG. 35 shows a touch sensor system 850 in accordance with another embodiment of the present invention. The touch sensor system 850 comprises a substrate 871 on which is formed a touch sensor 855 with a first edge adjacent to a first part 860A of a dynamic illuminator and a second edge adjacent to a second part 860B of the dynamic illuminator, in accordance with the present invention. A surface of the touch sensor system 850 is covered by a molding 870 having a first extension 870A and a second extension 870B. The first extension 870A and the second extension overhang, respectively, the first part 860A and the second part 860B of the dynamic illuminator. While FIG. 35 shows the extensions 870A and 870B terminating at the edges of the first part and second part 870A and 870B, respectively, it will be appreciated that the extensions 870A and 870B can extend farther along, terminating, for example, at the edge of the underlying substrate.

As explained above, dynamic illuminators are able to be used with all kinds of touch sensors, including, but not limited to, touch sensors that use mechanical, electrical, and optical sensor sensing techniques. FIG. 36, for example, shows a touch sensor system 900 that includes a miniature joystick 906 formed on a substrate 901 and surrounded by a dynamic illuminator 905. As one example, the joystick forms part of a game device (the host device), the joystick is used to steer and accelerate a vehicle simulated using the game device, and an intensity of the dynamic illuminator indicates the speed of the vehicle.

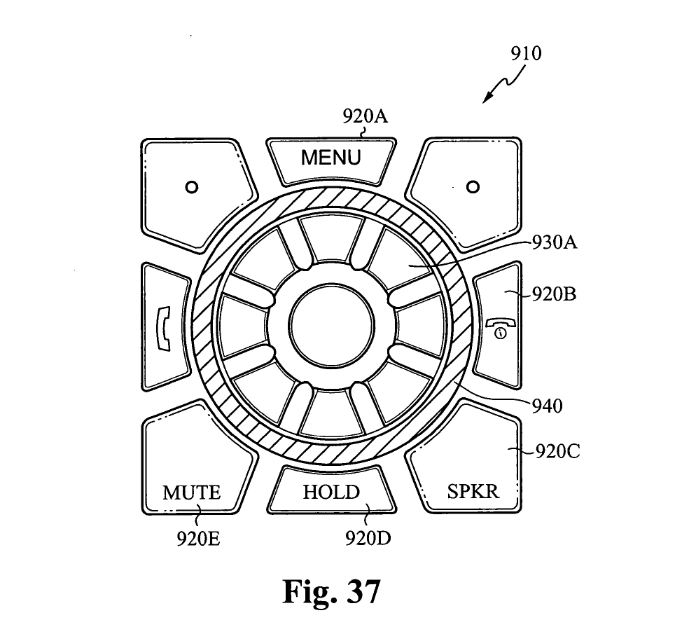

FIG. 37 shows a touch sensor system 910 that includes a 9-way pressure-sensitive directional control and a dynamic illuminator 940 that together form part of a portable telephone. The 9-way pressure-sensitive directional control includes an exemplary direction button 930A and exemplary selection buttons 920A for selecting a menu, 920B for dialing a telephone number, 920C for changing a speaker volume, 920D for placing a call on hold, and 920E for muting. As one example, when the button 920C is pressed, the dynamic illuminator 940 indicates the speaker volume on the portable telephone. The brighter the intensity, the louder the volume.

Still referring to FIG. 37, in as one example, a user has used the button 920A to select the option of entering a telephone number into a directory displayed on the telephone. The dynamic illuminator 940 will flash to indicate that the telephone is awaiting user input: a telephone number.

It will be appreciated that a dynamic illuminator in accordance with the present invention is able to indicate any status of a touch sensor system or of the host device to which the touch sensor system is attached.

It will be readily apparent to one skilled in the art that various modifications may be made to the embodiments without departing from the spirit and scope of the invention as defined by the appended claims.

We claim:

1. A touch sensor system having a contact area and comprising:
a. a substantially transparent molding positioned over the surface; and
b. a dynamic illuminator positioned to show through the molding.

2. The touch sensor system of claim 1, wherein the dynamic illuminator is for indicating a status of the touch sensor system.

3. The touch sensor system of claim 2, wherein the status is any one of power on, standby, error, and low power.

4. The touch sensor system of claim 2, wherein the status corresponds to an input mode for receiving user input.

5. The touch sensor system of claim 2, wherein the touch sensor system comprises any one of a joystick module, a touch-sensitive navigation disc, a touch sensing navigation pad, and a pressure-sensitive directional control.

6. The touch sensor system of claim 2, wherein the touch sensor system comprises a fingerprint sensor.

7. The touch sensor system of claim 6, wherein the status corresponds to an operating mode of the touch sensor system.

8. The touch sensor system of claim 7, wherein the operating mode is for emulating a selectable one of a scroll wheel, a push button, a steering wheel, a joy stick, a pressure button, and a mouse.

9. The touch sensor system of claim 7, wherein the operating mode comprises an authentication mode for authenticating an identity of a user.

10. The touch sensor system of claim 1, wherein the dynamic illuminator comprises one or more light channels configured to be illuminated in multiple configurations, each configuration corresponding to a status of the touch sensor system.

11. The touch sensor system of claim 10, wherein each configuration from the multiple configurations corresponds to an intensity of one or more of the one or more light channels.

12. The touch sensor system of claim 10, wherein each configuration from the multiple configurations comprises an illumination of the one or more light channels in a corresponding predetermined sequence.

13. The touch sensor system of claim 10, wherein each configuration from the multiple configurations comprises an illumination of a corresponding predetermined combination of light channels from the one or more light channels.

14. The touch sensor system of claim 10, wherein each of the one or more light channels is a different color.

15. The touch sensor system of claim 1, further comprising a substrate having a metal surface disposed below the molding and for reflecting illumination from the dynamic illuminator to a user.

16. The touch sensor system of claim 1, wherein the dynamic illuminator surrounds the contact area.

17. The touch sensor system of claim 1, wherein the molding comprises a light channel.

18. A system comprising:
a. a means for detecting contact to a surface of a contact device; and
b. a means for indicating a status of the contact device.

19. The system of claim 18, wherein the means for indicating a status comprises a visual display.

20. The system of claim 19, wherein the visual display comprises any one or more of a light emitting diode, an illuminated optical fiber, and an illuminated optical ribbon.

21. The system of claim 18, wherein the means for detecting contact comprises any one of a joystick module, a touch-sensitive navigation disc, a touch sensing navigation pad, and a pressure-sensitive directional control.

22. The system of claim 18, wherein the means for detecting contact comprises a fingerprint sensor.

23. The system of claim 22, wherein the fingerprint sensor comprises a fingerprint swipe sensor.

24. The system of claim 22, wherein the fingerprint sensor comprises a fingerprint placement sensor.

25. The system of claim 18, wherein the status is any one of power on, standby, error, and low power.

26. The system of claim 18, wherein the status corresponds to an input mode in which the system awaits contact to the contact area.

27. The system of claim 22, wherein the status corresponds to an emulation mode.

28. The system of claim 22, wherein the status corresponds to an authentication mode.

29. A method of fabricating an electronic device comprising:
a. forming a touch sensor having a contact surface;
b. forming a dynamic illuminator for indicating a status of the touch sensor; and
c. forming a substantially transparent molding over the surface and the dynamic illuminator.

30. The method of claim 29, wherein the touch sensor comprises any one of a joystick module, a touch-sensitive navigation disc, a touch-sensing navigation pad, and a pressure-sensitive directional control.

31. The method of claim 29, wherein the touch sensor is a fingerprint sensor.

32. The method of claim 31, wherein the fingerprint sensor is a fingerprint swipe sensor.

33. The method of claim 31, wherein the fingerprint sensor is a fingerprint placement sensor.

34. The method of claim 29, wherein the status is any one of power on, standby, error, and low power.

35. The method of claim 31, wherein the status corresponds to an operating mode of the touch sensor.

36. The method of claim 35, wherein the operating mode is an emulation mode for emulating any one of a scroll wheel, a push button, a steering wheel, a joy stick, a pressure button, a key pad, and a mouse.

37. The method of claim 35, wherein the operating mode comprises an authentication mode.

38. The method of claim 29, wherein the dynamic illuminator comprises one or more light channels configured to indicate a status of the touch sensor.

39. The method of claim 29, wherein the touch sensor is formed on a substrate, the method further comprising forming a metal surface below the molding for reflecting illumination from the dynamic illuminator to a user.

40. The method of claim 29, wherein the molding comprises a light channel.
